(19) United States
(12) Patent Application Publication
(10) Pub. No.: US 2005/0079856 A1
(43) Pub. Date: Apr. 14, 2005

(54) Method for providing a service using a communication network

(75) Inventors: Manfred Lilge, Berlin (DE); Thomas Ryll, Wolfsburg (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/934,760

(22) Filed: Sep. 7, 2004

(30) Foreign Application Priority Data
Sep. 8, 2003 (DE) 103 42 065.7

(51) Int. Cl. H04M 11/00

(52) U.S. Cl. 455/406; 455/408

(57) ABSTRACT

A method for providing a service for a plurality of service users using a telecommunication network, where a service message which is common to service users being transmitted from a service-providing service facility to a distribution computer in the telecommunication network, the distribution computer transmitting a billing message to a billing system in the telecommunication network, where the billing message includes an identifier for the service, the billing system using the identifier for the service to access a service-user data record in which the service users are recorded, the billing system performing payment assurance for the service for the service users recorded in the service-user data record, and the distribution computer then being used to provide the service for those of the plurality of service users for whom the payment assurance for the service has been performed successfully.

### CLAIM FOR PRIORITY

This application claims priority to German Application No. 10342065.7 filed Sep. 8, 2003, which is incorporated herein, in its entirety, by reference.

### TECHNICAL FIELD OF THE INVENTION

The invention relates to a method for providing a service for a plurality of service users using a communication network.

### BACKGROUND OF THE INVENTION

It is general knowledge that service providers in telecommunication networks provide services for a service user. Such a service may involve, for example, the transmission of information with a monetary value from the service provider to the service user. This transmission may involve the transmission of, by way of example, written short messages (SMS), text files or else ring tones to the service user. Provision of the service often involves billing for the service being carried out in order to invoice the service user for charges for providing the service.

### SUMMARY OF THE INVENTION

The invention discloses a method which can be implemented with little complexity and can be used to provide a service for a plurality of service users.

In one embodiment of the invention, there is a method for providing a service for a plurality of service users using a telecommunication network, where the method involves a service message which is common to service users being transmitted from a service-providing service facility to a distribution computer in the telecommunication network, the distribution computer transmitting a billing message to a billing system in the telecommunication network, where the billing message contains an identifier for the service, the billing system using the identifier for the service to access a service-user data record in which the service users are recorded, the billing system performing payment protection for the service for the service users recorded in the service-user data record, and the distribution computer then being used to provide the service for those of the plurality of service users for whom the payment assurance has been performed successfully. In this context, it is particularly advantageous that the distribution computer transmits one (generally short) identifier for the service with the billing message, and the billing system can use this identifier to access the service-user data record. Hence, particularly the distribution computer does not need to transmit separate identity features to the billing system for every single service user. As a result, a small volume of data to be transmitted is produced on the interface between the distribution computer and the billing system, which means that such an interface can be implemented easily and with little complexity.

In another embodiment of the invention, the service is provided for the service users by virtue of the distribution computer transmitting a service data message to the service users' communication terminals. As a result, the inventive method may advantageously be used for transmitting “Premium Content” (e.g. information with a monetary value, for example, such as exclusive messages, stock market prices or financial information) to the service users.

The service data message used in the method may be the service message or a modified service message. In this context, a modified service message should be understood to mean a message which includes the service message's fundamental information intended for the service users but which may have a different structure than the service message in detail, for example.

The inventive method may proceed in a manner such that the billing system performs separate payment assurance for the service for each service user in the service-user data record (for individual service users), and successful payment assurance for the service in relation to one of the service users prompts the distribution computer to provide the service for the service user one regardless of the success of the payment assurances relating to the other service users. In this case, it is particularly advantageous that when providing the service for the service user it is not necessary to wait until the payment assurances for the service users have been completed successfully. Rather, the service can be provided immediately after successful conclusion of the payment assurance for the one service user. This results in a method which can be performed extraordinarily quickly.

In yet another embodiment of the invention, in the case of successful payment assurance for one of the service users, the service is provided for the one service user at a parallel time with the payment assurances being performed for the service users for whom successful payment assurance is not yet available at this time. This simultaneous or at least temporally intersecting or overlapping service provision and payment assurance for the service advantageously achieve a very rapidly executed method. This ultimately results in the various service users being able to use their desired service very quickly and in long waiting periods being avoided.

In line with the invention, the method may proceed in a manner such that the billing system transmits a payment assurance confirmation message to the distribution computer when the payment assurance for a service user has been performed successfully, and the distribution computer is then used to provide the service for this service user. In this case, it is advantageous that the distribution computer can start to provide the service for the service user immediately following receipt of the payment assurance confirmation message.

In still another embodiment of the invention, the service-user data record is stored in a data store to which both the billing system and the distribution computer have access, the billing system stores service-user-related payment assurance information in the data store when the payment assurance for a service user has been performed successfully, the distribution computer reads from the service-user data record information about the service user for whom the service-user-related payment assurance information is stored in the data store, and the distribution computer is then used to provide the service for this service user. In this case, the distribution computer may advantageously read the payment assurance information from the data store when the distribution computer has sufficient capacity available for providing the service. The advantageous effect achieved through the direct access and reading option is thus, by way of example, that the message transmission capacity or the message distribution capacity of the distribution computer may be utilized particularly well.

In line with the invention, in another embodiment, at pre-selected time intervals or at pre-selected times the distribution computer reads from the service-user data record information about a plurality of the service users for whom the service-user-related payment assurance information is stored in the data store, and the distribution computer is then used to provide the service for those service users for whom the information has been read from the service-user data record. As a result of information being read about a plurality of service users in one reading operation, the number of reading operations required is reduced overall. Particularly taking into account a “data overhead” which often arises for each reading operation during data transmission, this achieves the effect that small volumes of data need to be transmitted to the distribution computer when reading the data store.

One aspect of the invention may involve the billing system and/or the distribution computer accessing the data store using the “Lightweight Directory Access Protocol” data transmission protocol.

Another aspect of the invention may involve the payment assurance for the service being performed in various ways. For example, it is regarded as advantageous for the payment assurance for the service to be performed by debiting an account sum associated with the service from an account belonging to the service user.

The invention may also proceed in a manner such that the payment assurance for the service is performed by reserving an account sum associated with the service in an account belonging to the service user. In this case, the account sum is debited later after the service has been provided.

Preferably, the reserved account sum is debited from the account after the distribution computer has been used to provide the service. This avoids the account sum being debited from the account belonging to the service user when provision of a service has failed.

The account used may be a prepaid credit account belonging to the service user. This advantageously allows the inventive method to be used together with “Prepaid Accounts” which are known per se in telecommunication networks.

The inventive method may also proceed in a manner such that a charge ticket for later invoicing which is associated with the service user is produced for the purpose of payment assurance for the service. In this embodiment of the inventive method, charge invoicing facilities (postprocessing billing systems) which are known per se in telecommunication networks may advantageously be used for billing.

“Payment assurance for the service” within the context of this invention is thus understood, by way of example, to mean debiting a sum of money from an account, reserving the sum of money in the account (debiting is then performed later) or else producing charge tickets relating to the sum of money.

### BRIEF DESCRIPTION OF THE DRAWINGS

The invention is explained below in more detail with reference to the drawings, in which:

FIG. 1 shows an exemplary embodiment of a telecommunication network together with an exemplary method.

FIG. 2 shows a further exemplary embodiment of a telecommunication network together with further exemplary methods.

FIG. 3 shows a further exemplary embodiment of the invention with reservation of account sums.

FIG. 4 shows exemplary embodiments of service user data records stored in a data store.

### DETAILED DESCRIPTION OF THE INVENTION

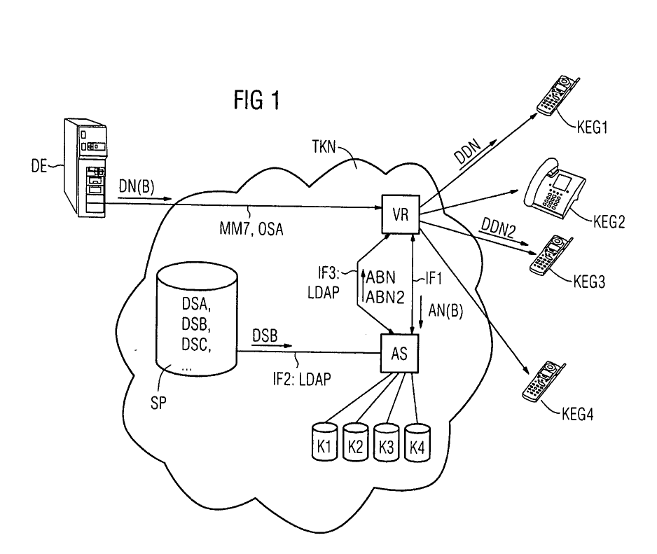

FIG. 1 shows a telecommunication network TKN having network elements which are fundamental to the invention. This telecommunication network may be a second or third generation mobile radio network or else a telephone landline network, for example. The telecommunication network TKN has a distribution computer VR, which is a multicast server in the exemplary embodiemnt. Such a distribution computer VR is also called a broadcast multicast service center (BM-SC) and is known from the printed document “3GPP TR 23.846 6.1.0 (2002-12), Technical Report, 3rd Generation Partnership Project; Technical Specification Group Services and System Aspects; Multimedia Broadcast/Multicast Service (MBMS); Architecture and functional description, (Release 6)”, particularly from section 6.7. The telecommunication network TKN is managed and administered by a network operator.

Connected to the distribution computer VR is a service-providing service facility DE (which is also called an application server, service server or content server and is managed by a service provider). In the example, this service facility DE is a server in a computer network from which a multimedia message (MMS) is intended to be sent to a group of service users. In the exemplary embodiment, the service to be provided is thus the transmission of a message (multimedia message) from a server to a plurality of communication terminals belonging to service users. In this case, the plurality of service users (service receivers) receive homogeneous messages (in real time) via their communication terminals. To this extent, a service (sending of a message) is provided for a plurality of service users. The service facility DE is connected to the distribution computer VR by means of a data link which can be used to interchange data, for example using the inherently known interface MM7 (cf. 3GPP TS 23.140 V6.2.0 standard (2003-06), Technical Specification, 3rd Generation Partnership Project; Technical Specification Group Terminals; Multimedia Messaging Service (MMS); Functional description; Stage 2 (Release 6), particularly section 8.7) or using the inherently known OSA interface. The distribution computer VR is connected (at least temporarily) to a first communication terminal KEG1 belonging to a first service user, a second communication terminal KEG2 belonging to a second service user, a third communication terminal KEG3 belonging to a third service user and a fourth communication terminal KEG4 belonging to a fourth service user. In the example, the first, third and fourth communication terminals are mobile telephones, and the second communication terminal is a landline telephone. Further communication terminals may also be used, however, for example portable computers with a mobile radio interface, personal digital assistants (PDAs) or palmtops.

At the start of the method, the service facility DE belonging to an MMS service provider transmits a service message DN to the distribution computer VR via the aforementioned data link. This data message DN contains all information needing to be transmitted to the communication terminals using the multimedia message; by way of example, the service message DN contains the full multimedia message MMS. In addition, the service message DN is used to transmit an identifier B for the service which is to be provided (in the exemplary embodiment, the service of transmitting the message MMS to selected communication terminals is called “service B” for short). The method involves the general transmission of a service message to the distribution computer, this service message prompting provision of the service for the plurality of service users. This service message DN thus transmits an instruction to the network operator's telecommunication network to provide service B. In this exemplary embodiment, the “premium content” to be transmitted using the multimedia message MMS is likewise transmitted to the telecommunication network using the service message DN; in another exemplary embodiment, however, this “premium content” could also be present in the telecommunication network TKN, e.g. in a database, and could be retrieved from this database by the distribution computer VR. The distribution computer VR knows the type of service which is to be provided by the telecommunication network TKN from the identifier B which is also transmitted with the service message DN. To perform payment assurance relating to service B, the distribution computer VR sends a billing message AN, including the identifier B for the service, to a billing system AS (charging system) in the telecommunication network TKN. Such billing systems are used in telecommunication networks to bill for charges and costs, with “prepaid billing systems” and “postpaid billing systems” (postprocessing billing systems), for example, being known generally.

The identifier B for the service is a reference to a service-user data record which is described in detail below (in the exemplary embodiment, to the service-user data record DSB). The data transmission between the distribution computer VR and the billing system AS takes place via an interface IF1 with real-time capability, which may also be referred to as an “Online Interface”. This interface IF1 permits access to the billing system and to account-managing systems connected downstream thereof.

A data store SP (for example a database) in the telecommunication network TKN stores service-user data records DSA, DSB, DSC etc. which are respectively associated with a service A, B, C etc. In particular, the service-user data record DSB is stored for service B described in the exemplary embodiment. In another exemplary embodiment, these service-user data records may also be stored in a memory in the distribution computer VR.

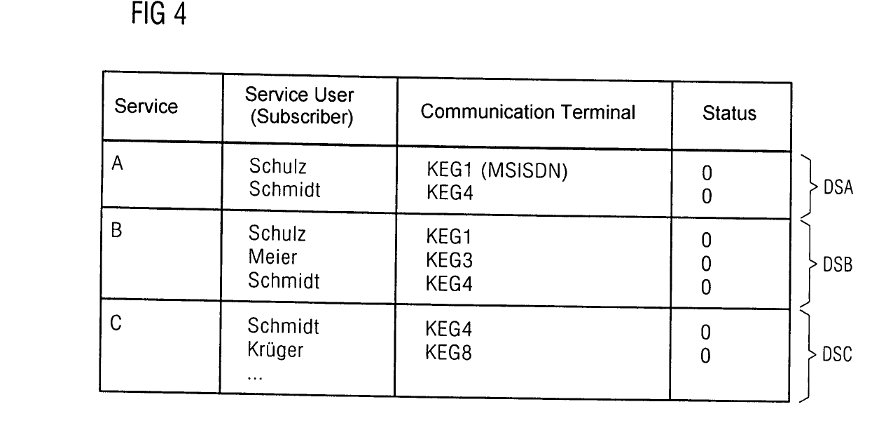

FIG. 4 shows, by way of example, the content of the three service-user data records DSA, DSB and DSC. The service-user data record DSB contains the identifier B (e.g. a code number) for service B, names or other identification features of the subscribers (service users) Schulz, Meier & Schmidt who have subscribed to service B, identities (e.g. telephone numbers MSISDN) for the communication terminals KEG1, KEG3 and KEG4 used by the service users, and a status for each service user or for his communication terminal. This status has a value “0” (zero) as a preset (default value); in addition, the status may assume the values “CP”, “CNS”, “CS”, “RP”, “RNS”, “RS”, “MSS” and “MNS”. These status values have the following meanings:

Status CP: Charging Pending

Status CNS: Charging Not Successful,

Status CS: Charging Successful,

Status RP: Reservation Pending,

Status RNS: Reservation Not Successful,

Status RS: Reservation Successful,

Status MSS: Message Sent Successfully, i.e. service provided,

Status MNS: Message Not Sent, i.e. service not provided.

The service-user data record DSB thus includes the information that the service users Schulz, Meier and Schmidt are subscribed to service B, service user Schulz using the communication terminal KEG1 and the status of service user Schulz still having its default value “0”. In addition, service user Meier uses the communication terminal KEG3 and has the default status “0”; service user Schmidt uses the communication terminal KEG4, which likewise has the default status “0”. Similarly, service-user data records DSA and DSC are stored in the data store SP for further services A and C.

FIG. 1 also shows how the billing system AS, having received the billing message AN (B), uses the identifier B for the multimedia service to read the data in the service-user data record DSB from the data store SP. The billing system AS discovers from the service-user data record DSB that service user Schulz has subscribed to service B. Service user Schulz has an associated account K1 which can be accessed by the billing system AS. In the exemplary embodiment, the account K1 is a prepaid account into which service user Schulz has paid an adequate credit sum before the start of the method. The billing system AS now debits an account sum associated with service B (e.g. 2 euros) from the credit account K1 belonging to service user Schulz and thus assures the payment relating to service B for service user Schulz. In this case, the payment assurance for service user Schulz is performed individually, i.e. the payment assurance for service user Schulz takes place independently of payment assurances for the other service users Meier and Schmidt. The account sum to be debited is a charge or a price which is to be paid by the service user for provision of the service. The account sum may have various forms, for example it may be in the form of a sum of money, a number of telephone units or, generally, a number of credit units. The level of the account sums to be applied for the various services may be stored in the billing system AS or in the memory SP.

As soon as the payment assurance for service B is successful for service user Schulz (for example because the account K1 belong to service user Schulz has a credit which is large enough for debiting the account sum), the billing system AS sends a payment assurance confirmation message ABN (clearly denoting service user Schulz or his communication terminal KEG1) to the distribution computer VR. As soon as the distribution computer VR receives this payment assurance confirmation message ABN, it provides the service for service user Schulz by sending a service data message DDN in the form of the multimedia message MMS to the communication terminal KEG1 belonging to service user Schulz. In this case, the service data message DDN used may be the service message DN (in this case, a service message DN is used which already has the form of the multimedia message MMS); alternatively, a modified service message is used (in this case the service message DN contains, by way of example, the information which is to be transmitted using the multimedia message MMS; this information is written to the service data message DDN, but the service data message DDN has an altered, modified form as compared with the service message DN).

In this case, the payment assurance confirmation message ABN is not transmitted to the distribution computer VR via the interface IF1; rather, the payment assurance confirmation message ABN is transmitted between the billing system AS and the distribution computer VR via an interface IF3 using the “Lightweight Direction Access Protocol” (LDAP) data transmission protocol.

Immediately after the billing system AS has sent the payment assurance confirmation message ABN to the distribution computer VR, the billing system AS starts the payment assurance for service B for the second service user Meier who is recorded in the service user data record DSB. To this end, the billing system AS accesses a charge account K3 belonging to service user Meier and deducts the charge sum associated with service B from this account K3; this charge sum is debited from the account K3. This payment assurance relating to service user Meier for service B takes place at a parallel time with the sending of the service data message DDN from the distribution computer VR to the first communication terminal KEG1. The service is thus provided for service user Schulz (for whom successful payment assurance has already taken place) at a parallel time or simultaneously with the payment assurance for service B relating to service user Meier (for whom successful payment assurance has not yet taken place). The effect achieved by this is that the billing system AS does not have to wait for provision of the service via the distribution computer VR to end. Equally, the distribution computer VR does not have to wait for payment assurance for service B for all of the users in the service-user data record DSB to end. This results in very fast execution of the method.

The billing system AS thus transmits the payment assurance confirmation message ABN to the distribution computer VR as soon as the payment assurance for a service user has ended successfully. Next, the distribution computer VR provides the service for this very service user without waiting for the payment assurance for the other service users to end.

Upon successful payment assurance for the service for a service user, the service is thus provided for this service user, regardless of whether or not other payment assurances for other service users in the service-user data record have had a successful outcome.

As soon as the payment assurance for service user Meier has ended successfully, a further payment assurance confirmation message ABN2, relating to service user Meier, is transmitted to the distribution computer VR. Immediately after receiving the payment assurance confirmation message ABN2, the distribution computer VR provides service B by virtue of the distribution computer VR sending a second service data message DDN2 to the third communication terminal KEG3 belonging to service user Meier. While the distribution computer VR is still in the process of sending the second service data message DDN2, the billing system AS actually performs the payment assurance for service B for the third service user Schmidt in the service-user data record DSB. The sequence is then repeated accordingly.

Should successful payment assurance not be performed for a service user, the billing system AS does not send a payment assurance confirmation message to the distribution computer, but rather automatically starts payment assurance for the next service user recorded in the service-user data record DSB.

Payment assurance for the service may also be performed by the billing system AS by virtue of a charge ticket (charge data record) associated with the appropriate service user being produced which is later used during an invoicing process (postprocessing).

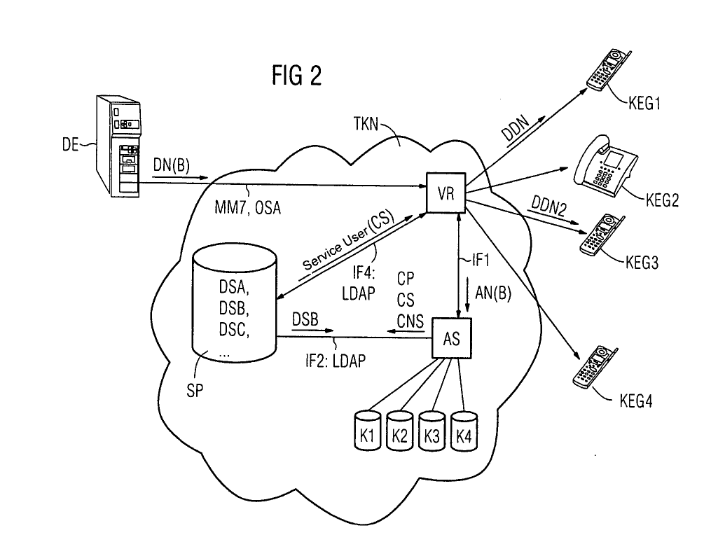

FIG. 2 shows a further exemplary embodiment of the inventive method, which largely corresponds to the method described in connection with FIG. 1. Unlike in the method shown in FIG. 1, the method shown in FIG. 2 involves not only the billing system AS but also the distribution computer VR having access to the service-user data record DSB stored in the data store SP. As soon as the billing system AS has successfully completed payment assurance for a service user (for example for service user Schulz in the service-user data record DSB), the billing system AS stores payment assurance information for the service user (e.g. for service user Schulz) in the data store SP. To store this service-user-related payment assurance information, the billing system AS writes an entry to the service-user data record DSB in the data store SP, i.e. the billing system AS writes changes to the service-user data record DSB. This alters the status of service user Schulz; instead of the status information 0 (default) which is preset as standard, the status information “CS” (Charging Successful) is written to the service-user data record DSB as the status of service user Schultz. The status information “CS” is thus the service-user-related payment assurance information which is stored in the data store SP when the payment assurance for a service user has been performed successfully.

In the period between the start of the payment assurance for a service user and successful or unsuccessful conclusion of the payment assurance, it is possible to set the status for this service user to “CP” (Charging Pending). In the event of unsuccessful conclusion of the payment assurance for a service user, the status for this service user is set to “CNS” (Charging Not Successful).

The distribution computer VR reads information about the service user(s) for whom the service-user-related payment assurance information is stored in the data store SP from the data store SP continuously at preselected (e.g. short) intervals of time or at preselected times. In this case, in a reading operation, respective information about a plurality of service users and their communication terminals for whom/which the status has been set to “CS” (Charging Successful) beforehand, for example, is read from the service-user data record. After every such reading operation, the distribution computer VR is used to provide the service for these service users or their communication terminals by virtue of service data messages being transmitted from the distribution computer VR to the appropriate communication terminals. In this case, after a single reading operation, a respective service data message may be sent to a plurality of communication terminals (which are associated with a plurality of service users). The billing system AS and the distribution computer VR access the data store SP using the data transmission protocol LDAP.

In both described embodiments of the inventive method, the billing system AS thus performs the payment assurance (in the form of a debit operation) for the service and at the same time the distribution computer VR provides the service by sending the appropriate service data messages to the communication terminals.

As soon as the billing system AS has performed payment assurance for all of the service users in the service-user data record and (in the case of successful payment assurance) has set the status of the respective service user to “CS” or (in the case of unsuccessful payment assurance) has set the status to “CNS”, the billing system terminates the payment assurance for this service. When the distribution computer VR has used the service data messages to deliver the “premium content” (valuable data) to all service users with the status “CS”, provision of the service is at an end for the distribution computer VR.

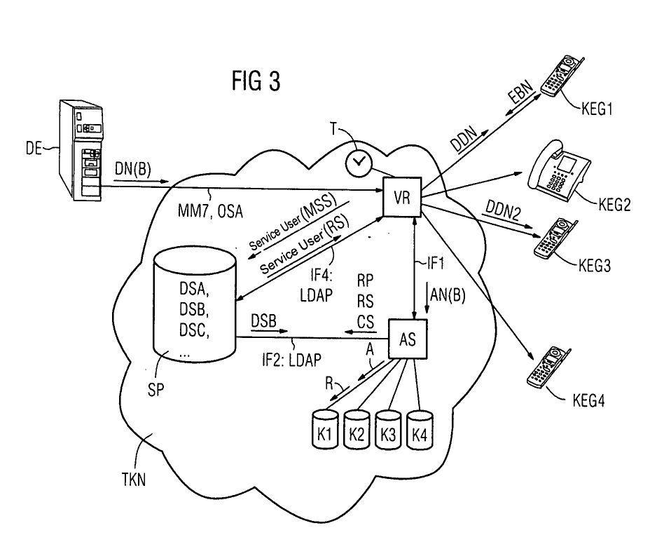

FIG. 3 shows a further exemplary embodiment of the inventive method, in which the billing system AS performs payment assurance for the service by making a reservation in an account belonging to the service user in line with the service used. The start of this method corresponds to the methods described in connection with FIGS. 1 and 2.

When the billing system AS has received the billing message AN, the billing system AS ascertains the price for using service B and makes an appropriate reservation of funds. The billing system AS first uses a reservation message R to reserve a sum of money associated with service B in the account K1 belonging to service user Schulz. At the start of the reservation operation, the billing system AS writes a status “RP” (Reservation Pending) to the service-user data record DSB for service user Schulz in order to flag that a reservation is currently being made for service user Schulz. The account K1 belonging to service user Schulz is thus debited with an account sum associated with service “B” by virtue of a sum of money which corresponds to the account sum being reserved in the account. If the reservation has been terminated successfully, because the account K1 belonging to service user Schulz includes a credit sum which is large enough for the reservation, the billing system AS alters the service-user data record DSB such that the status “RS” (Reservation Successful) is entered into the service-user data record DSB for service user Schulz. Should the reservation not proceed successfully (for example because the account K1 does not have sufficient credit), then the status for service user Schulz is set to “RNS” (Reservation Not Successful). In this exemplary embodiment, payment assurance is thus performed for the service by making a reservation in the service user's account in line with the level of the account sum which is to be debited for the service (e.g. a sum of money).

As soon as this reservation and hence the payment assurance for the service has concluded successfully, the service is provided for the service user using the distribution computer VR. To this end, the distribution computer VR periodically reads the data in the service-user data record DSB from the memory SP via the interface IF4. The distribution computer VR then provides the service in a known manner for those subscribers for whom the reservation was successful (that is to say for whom the status “RS” has been entered in the service-user data record).

In this exemplary embodiment, the distribution computer VR thus provides the service for those subscribers for whom a successful reservation has already been made. At the same time, the billing system AS makes reservations for further subscribers to the service in question.

In this exemplary embodiment, the service is provided for the subscriber Schulz by transmitted the service data message DDN to the communication terminal KEG1 belong to subscriber Schulz—as in the case of the exemplary embodiments shown in FIGS. 1 and 2. A reception device (for example a client application in the mobile telephone KEG1) receives the service data message DDN and then returns a reception confirmation message EBN to the distribution computer VR. Next, the distribution computer VR changes the status of service user Schulz to “MSS” (Message Sent Successfully), since the service has been provided successfully for this service user (the multimedia message DDN has been transmitted successfully to the service user).

For each service user, the distribution computer VR monitors a timer unit T and attempts to provide the service for the service user within a predetermined period of time, i.e. in this exemplary embodiment it attempts to transmit the service data message DDN to the communication terminal KEG1. If it is not possible to transmit (deliver) the service data message and hence to provide the service within the predetermined period of time, the distribution computer VR changes the status for the respective service user to “MNS” (Message Not Sent). This stores the information that the service could not be provided for the service user.

From the service-user data record DSB, the billing system AS now reads at regular intervals the information regarding whether service users in this service-user data record have the status “MNS”. If this is the case, then the reservation is reversed for these service users (reservation cancelled), i.e. the reserved sums in the accounts belonging to these service users are released again. This takes account of the fact that the service could not be provided for these service users.

The billing system AS likewise reads from the memory SP at regular intervals the information regarding those service users for whom the status “MSS” (Message Sent Successfully) has been entered into the service-user data record by the distribution computer VR. For these subscribers (in the example, for service user Schulz), the account sum already reserved is debited from the account using a debit message A, since the service has been provided for these subscribers. Following successful debiting of the reserved account sums, the status for these subscribers is set to “CS” (Charging Successful).

In this exemplary embodiment, the method is ended when either the status “CS” (Charging Successful) or the status “RNS” (Reservation Not Successful) has been set for all of the service users in the service-user data record DSB. At the start of a new method sequence (i.e. when a new service message and a new billing message appear), the status is reset to the default setting “0”.

FIG. 3 has been used to describe an exemplary embodiment of the inventive method in which the billing system AS makes a reservation of account sums in accounts belonging to service users and at the same time the distribution computer VR provides the service for such service users as have already had a successful reservation made for them. In this exemplary embodiment, prior to provision of the service, an account sum is reserved for the respective service and the reserved account sum is debited from the account after successful provision of the service. The success of provision of the service is ascertained by virtue of a reception check for the service data message DDN being performed on the communication terminal KEG1 and, in the case of successful receipt of the service data message DDN, the reception confirmation message EBN being sent to the distribution computer VR.

The above text has described methods which can be used to provide (perform) a service for a plurality of service users using a telecommunication network. Particularly with a very large number of service users (in the case of “bulk services”, often with several thousand service users), efficient billing for the service which is to be provided is made possible. In this case, particularly the interface IF1 (Online Charging Interface) between the distribution computer VR and the billing system AS is burdened with the transmission of small volumes of data, which means that this interface may also be used by other network elements (for example other distribution computers) to perform payment assurances or billing operations for charging for services. In addition, particularly this interface needs to be designed for low data transmission rates. The timing of provision of the service in the form of the sending of messages to the communication terminals is linked to the payment assurance (reservation of resources in accounts belonging to the service users, debiting of resources for the accounts belonging to the service users and/or production of charge tickets for later invoicing). Service provision and payment assurance at parallel times means that, at the start of sending the individual service data messages to the service users, it is not necessary to wait until the payment assurance for all of the service users of the service has ended successfully. This results in a very fast method for providing bulk services, and efficient billing for these bulk services is performed.

1. A method for providing a service for a plurality of service users using a telecommunication network, comprising:
transmitting a service message which is common to service users from a service-providing service facility to a distribution computer in the telecommunication network, the distribution computer transmitting a billing message to a billing system in the telecommunication network, where the billing message includes an identifier for the service;
using the identifier for the service to access a service-user data record in which the service users are recorded;
performing payment assurance for the service for the service users recorded in the service-user data record; and
providing the service for the plurality of service users for whom the payment assurance for the service has been performed successfully.

2. The method as claimed in claim 1, wherein the service is provided for the service users by the distribution computer transmitting a service data message to the service users' communication terminals.

3. The method as claimed in claim 1, wherein the service data message used is the service message or a modified service message.

4. The method as claimed in claim 1, wherein the billing system performs separate payment assurance for each service user in the service-user data record, and successful payment assurance for the service in relation to one of the service users prompts the distribution computer to provide the service for the service user regardless of the success of the payment assurances relating to the other service users.

5. The method as claimed in claim 1, wherein if there is successful payment assurance for one of the service users, the service is provided for the service user at a parallel time with the service's payment assurances being performed for the service users for whom successful payment assurance is not yet available at this time.

6. The method as claimed in claim 1, wherein
the billing system transmits a payment assurance confirmation message to the distribution computer when the payment assurance for a service user has been performed successfully, and
the distribution computer is used to provide the service for this service user.

7. The method as claimed in claim 1, wherein
the service-user data record is stored in a data store to which both the billing system and the distribution computer have access,
the billing system stores service-user-related payment assurance information in the data store when the payment assurance for a service user has been performed successfully,
the distribution computer reads from the service-user data record information about the service user for whom the service-user-related payment assurance information is stored in the data store, and
the distribution computer is used to provide the service for the service user.

8. The method as claimed in claim 7, wherein at pre-selected time intervals or at pre-selected times the distribution computer reads from the service-user data record information about a plurality of the service users for whom the service-user-related payment assurance information is stored in the data store, and
the distribution computer is used to provide the service for the service users for whom the information has been read from the service-user data record.

9. The method as claimed in claim 7, wherein
the billing system and/or the distribution computer accesses the data store using the “Lightweight Directory Access Protocol” data transmission protocol.

10. The method as claimed in claim 1, wherein the payment assurance for the service is performed by debiting an account sum associated with the service from an account belonging to the service user.

11. The method as claimed in claim 1, wherein the payment assurance for the service is performed by reserving an account sum associated with the service in an account belonging to the service user.

12. The method as claimed in claim 11, wherein the reserved account sum is debited from the account after the distribution computer has been used to provide the service.

13. The method as claimed in claim 10, wherein the account used is a prepaid credit account belonging to the service user.

14. The method as claimed in claim 1, wherein a charge ticket associated with the service user is produced for payment assurance for the service.
